(19) United States
(12) Patent Application Publication
(10) Pub. No.: US 2014/0151204 A1
(43) Pub. Date: Jun. 5, 2014

(54) KEYSWITCH

(71) Applicants: DARFON ELECTRONICS CORP., Taoyuan (TW); DARFON ELECTRONICS (SUZHOU) CO., LTD., Suzhou (CN)

(72) Inventor: Ji-Huang Chen, Taoyuan (TW)

(73) Assignees: DARFON ELECTRONICS CORP., Taoyuan (TW); DARFON ELECTRONICS (SUZHOU) CO., LTD., Suzhou (CN)

(21) Appl. No.: 14/084,618

(22) Filed: Nov. 20, 2013

(30) Foreign Application Priority Data
Dec. 4, 2012 (TW) 101145445

(51) Int. Cl. H01H 13/02

(52) U.S. Cl. CPC H01H 13/02
USPC 200/310; 200/341

(57) ABSTRACT

A keyswitch includes a base, a first magnetic area, a key cap, a second magnetic area, a first linking bar and a second linking bar. The first magnetic area is disposed on the base. The second magnetic area is disposed on the key cap. A position of the second magnetic area is corresponding to a position of the first magnetic area. The first and second linking bars are disposed between the base and the key cap. The first and second linking bars are movably connected to the base and the key cap, so as to drive the key cap to move with respect to the base between a non-pressed position and a pressed position.

### BACKGROUND OF THE INVENTION

1. Field of the Invention

The invention relates to a keyswitch and, more particularly, to a keyswitch utilizing a magnetic attraction force to drive a key cap to move with respect to a base between a non-pressed position and a pressed position.

2. Description of the Prior Art

A conventional keyboard utilizes an upright elastomeric biasing member to provide an elastic return force for a key cap, such that the key cap can return to a non-pressed position. The upright elastomeric biasing member shown in U.S. Pat. No. 5,898,145 is usually made of rubber. However, the upright elastomeric biasing member may be a bottleneck for a slim keyboard since the upright elastomeric biasing member is limited to a specific height due to its dome like shape.

### SUMMARY OF THE INVENTION

Therefore, an objective of the invention is to provide a keyswitch utilizing a magnetic attraction force to drive a key cap to move with respect to a base between a non-pressed position and a pressed position.

According to an embodiment of the invention, a keyswitch comprises a base, a first magnetic area, a key cap, a second magnetic area, a first linking bar and a second linking bar. The first magnetic area is disposed on the base. The second magnetic area is disposed on the key cap, and a position of the second magnetic area is corresponding to a position of the first magnetic area. The first linking bar and the second linking bar are disposed between the base and the key cap. The first and second linking bars are movably connected to the base and the key cap, so as to drive the key cap to move with respect to the base between a non-pressed position and a pressed position. When the key cap is not pressed, a magnetic attraction force between the first magnetic area and the second magnetic area keeps the key cap at the non-pressed position. When the key cap is pressed by an external force such that the second magnetic area moves away from the first magnetic area, the key cap moves with the first and second linking bars from the non-pressed position toward the pressed position. When the external force is removed, the second magnetic area moves toward the first magnetic area due to the magnetic attraction force such that the key cap moves with the first and second linking bars from the pressed position toward the non-pressed position.

According to another embodiment of the invention, a keyswitch comprises abase, a first magnetic area, a key cap and a second magnetic area. The first magnetic area is disposed on the base. The key cap has a main body, a first extending arm and a second extending arm, wherein the first and second extending arms are rotatably connected to the base and capable of rotating in an identical direction, so as to drive the key cap to move with respect to the base between a non-pressed position and a pressed position. The second magnetic area is disposed on the key cap, and a position of the second magnetic area is corresponding to a position of the first magnetic area. When the key cap is not pressed, a magnetic attraction force between the first magnetic area and the second magnetic area keeps the key cap at the non-pressed position. When the key cap is pressed by an external force such that the second magnetic area moves away from the first magnetic area, the key cap moves with the first and second extending arms from the non-pressed position toward the pressed position. When the external force is removed, the second magnetic area moves toward the first magnetic area due to the magnetic attraction force such that the key cap moves with the first and second extending arms from the pressed position toward the non-pressed position.

As mentioned in the above, the invention disposes the first magnetic area on the base and disposes the second magnetic area on the key cap, wherein the position of the first magnetic area is corresponding to the position of the second magnetic area. Furthermore, the invention may dispose two linking bars, which are movably connected to the base and the key cap, between the base and the key cap or, alternatively, the invention may dispose two extending arms, which are rotatably connected to the base, on the key cap. When the key cap is not pressed, the magnetic attraction force between the first magnetic area and the second magnetic area keeps the key cap at the non-pressed position. When the key cap is pressed by the external force such that the second magnetic area moves away from the first magnetic area, the key cap moves with the two linking bars or the two extending arms from the non-pressed position toward the pressed position. When the external force is removed, the second magnetic area moves toward the first magnetic area due to the magnetic attraction force such that the key cap moves with the two linking bars or the two extending arms from the pressed position toward the non-pressed position. Since the upright elastomeric biasing member of the conventional keyswitch is unnecessary for the invention, the lifetime of the keyswitch of the invention can be extended effectively. Moreover, the invention replaces the support device of the conventional keyswitch with the two linking bars or the two extending arms, such that the structure of the keyswitch is simple, it is easy to assemble the keyswitch, and the keyswitch can be miniaturized easily.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a keyswitch according to an embodiment of the invention.

FIG. 2 is an exploded view illustrating the keyswitch shown in FIG. 1.

FIG. 3 is a side view illustrating the keyswitch shown in FIG. 1.

FIG. 4 is a side view illustrating the keyswitch shown in FIG. 3 without the key cap.

FIG. 5 is a side view illustrating the key cap shown in FIG. 3 being pressed.

FIG. 6 is a side view illustrating the keyswitch shown in FIG. 5 without the key cap.

FIG. 7 is a side view illustrating a keyswitch according to another embodiment of the invention.

FIG. 8 is a side view illustrating a keyswitch according to another embodiment of the invention.

FIG. 9 is a top view illustrating an assembly of the first linking bar, the second linking bar and the base.

FIG. 10 is a perspective view illustrating a key cap according to another embodiment of the invention.

### DETAILED DESCRIPTION

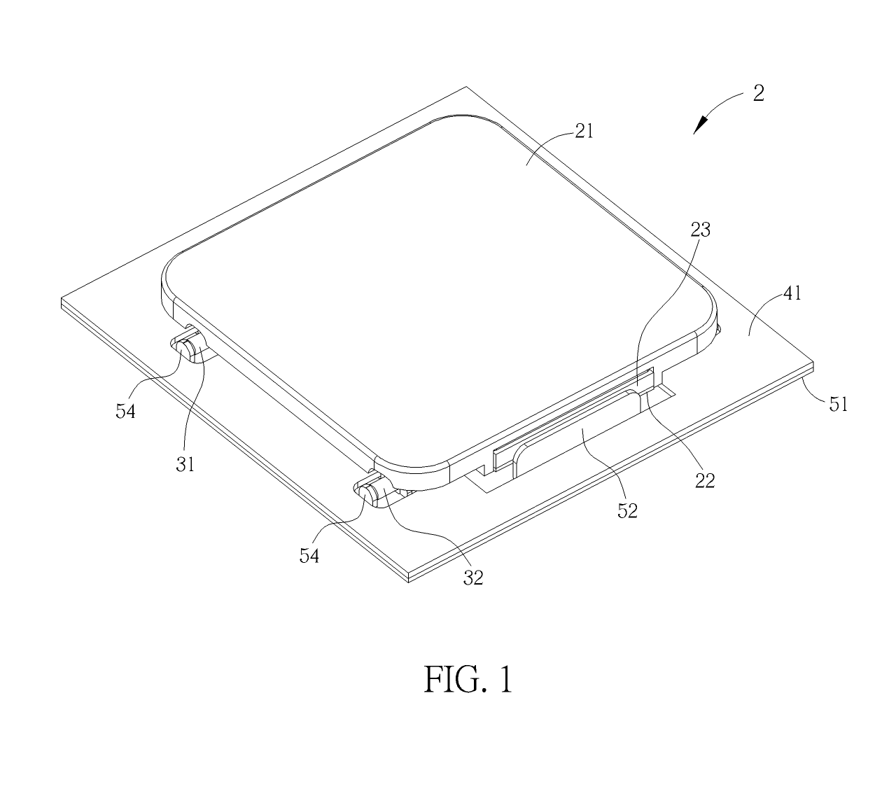

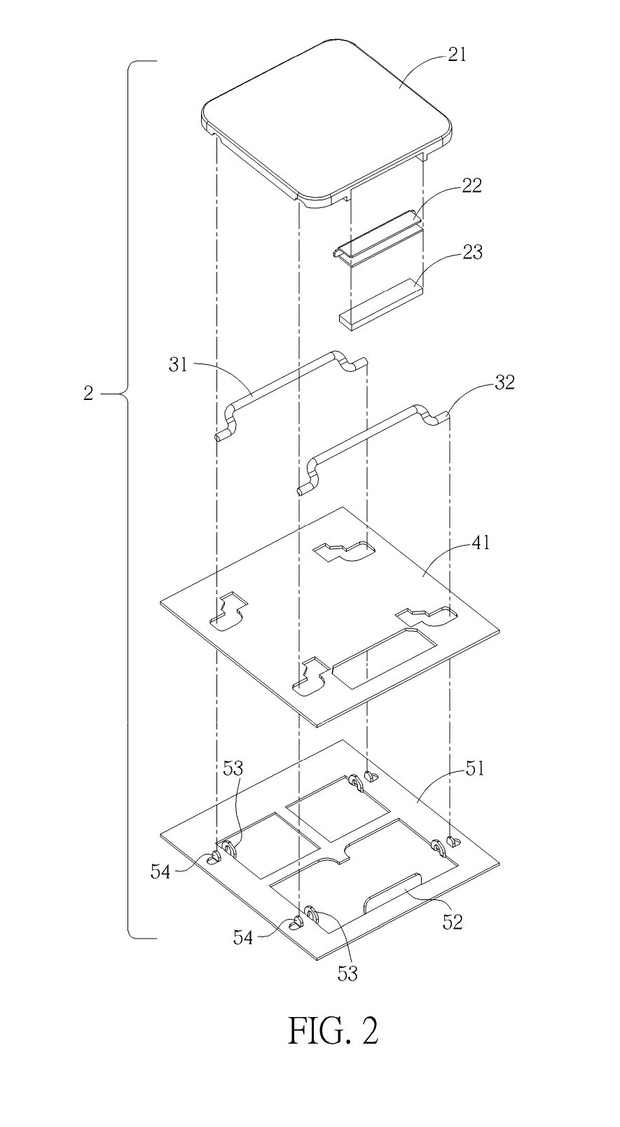

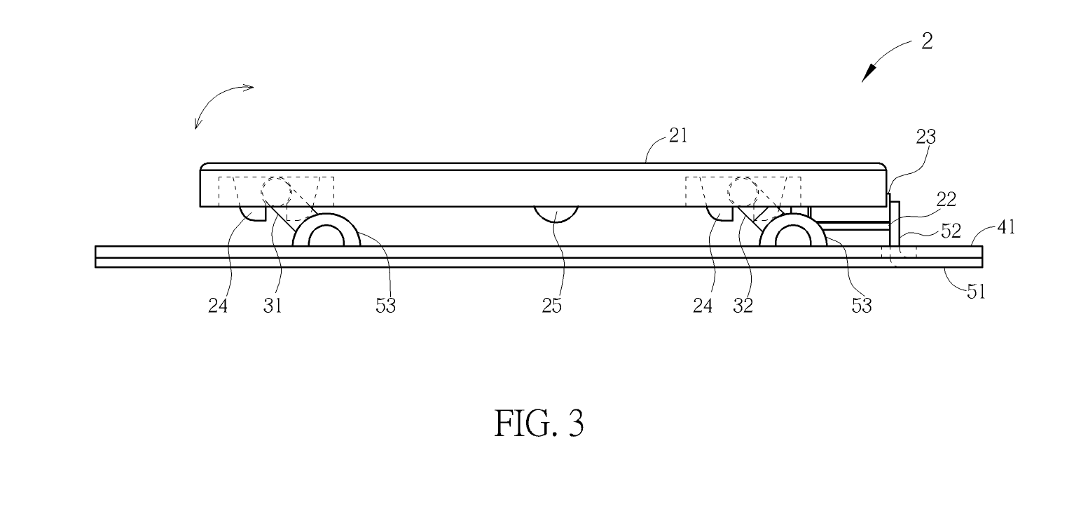

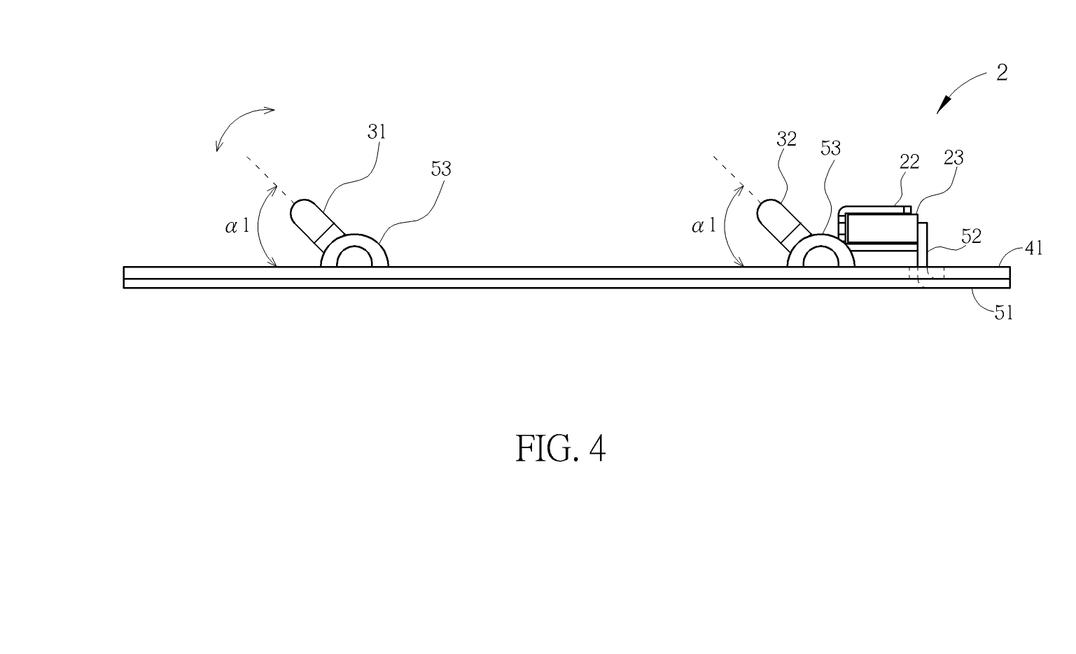

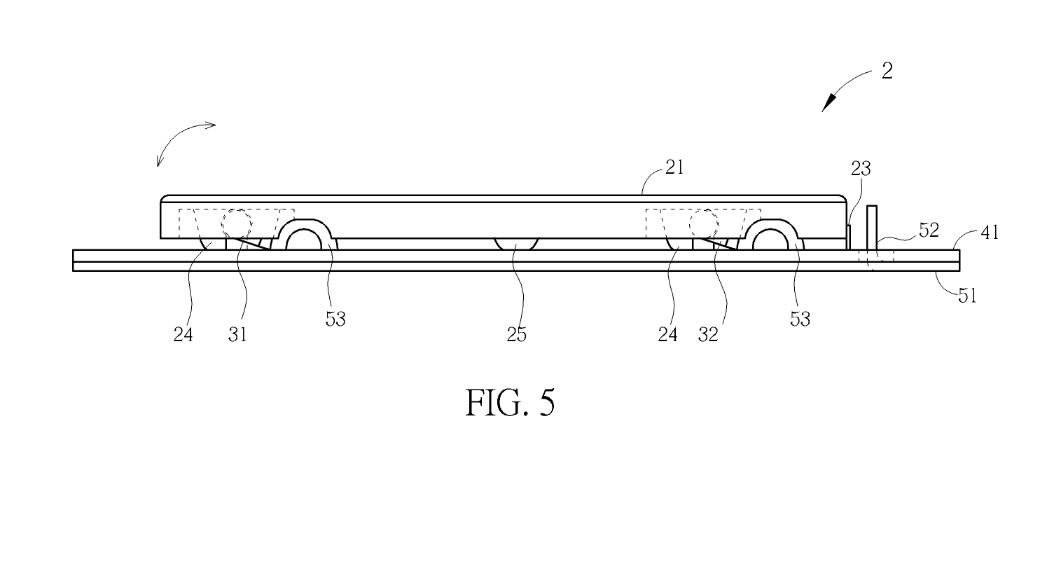

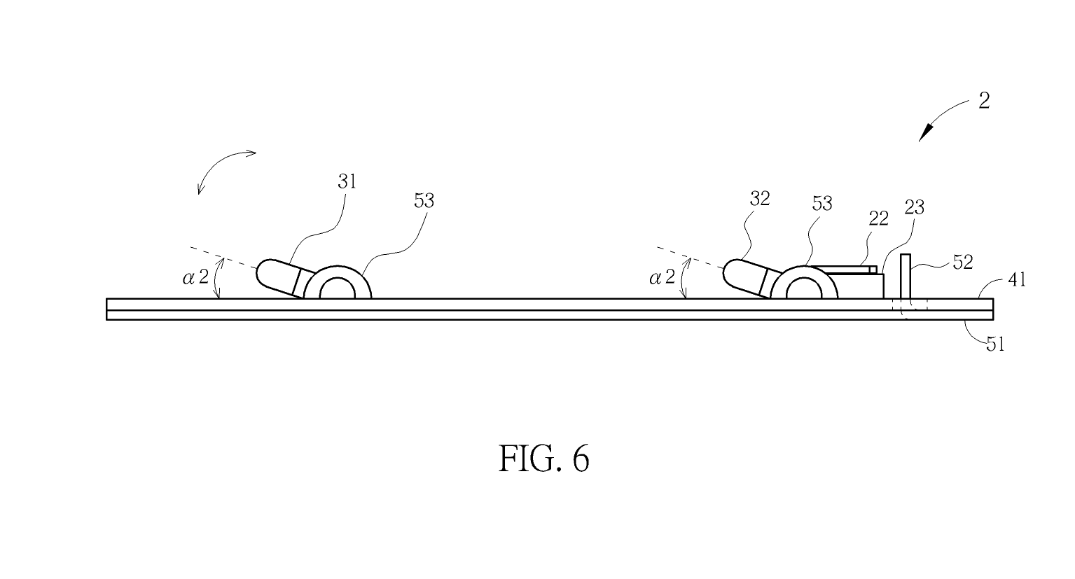

Referring to FIGS. 1 to 6, FIG. 1 is a perspective view illustrating a keyswitch 2 according to an embodiment of the invention, FIG. 2 is an exploded view illustrating the keyswitch 2 shown in FIG. 1, FIG. 3 is a side view illustrating the keyswitch 2 shown in FIG. 1, FIG. 4 is a side view illustrating the keyswitch 2 shown in FIG. 3 without the key cap 21, FIG. 5 is a side view illustrating the key cap 21 shown in FIG. 3 being pressed, and FIG. 6 is a side view illustrating the keyswitch 2 shown in FIG. 5 without the key cap 21. As shown in FIGS. 1 to 6, the keyswitch 2 comprises a key cap 21, a casing 22, a second magnetic area 23, a first linking bar 31, a second linking bar 32, a circuit board 41, a base 51 and a first magnetic area 52. In practical applications, the circuit board 41 may be, but not limited to, a membrane circuit board.

As shown in FIGS. 1 and 2, the first magnetic area 52 is disposed on the base 51, the second magnetic area 23 is disposed on a side of the key cap 21, and a position of the second magnetic area 23 is corresponding to a position of the first magnetic area 52. In another embodiment, the second magnetic area 23 may also be disposed on four corners or a center of a bottom of the key cap 21. In this embodiment, a side plate may be bent from the base 51 so as to form the first magnetic area 52. In other words, the first magnetic area 52 may be formed with the base 51 integrally. When the base 51 is made of a magnetic induction material (e.g. iron or other metals), the first magnetic area 52 is the magnetic induction material. In another embodiment, the keyswitch 2 may further comprise a frame (made of a magnetic induction material, not shown) disposed on the base 51 and the first magnetic area 52 may be provided by the frame. Furthermore, the casing 22 is disposed on the bottom of the key cap 21 and used for accommodating the second magnetic area 23, such that the second magnetic area 23 is disposed on the bottom of the key cap 21. In this embodiment, the second magnetic area 23 may be a magnetic object (e.g. magnet), such that a magnetic attraction force can be generated between the first magnetic area 52 and the second magnetic area 23. The casing 22 may be made of metal (e.g. iron). When the second magnetic area 23 is accommodated in the casing 22, the casing 22 can concentrate the magnetic field generated by the second magnetic area 23 at one side facing the first magnetic area 52, so as to enhance the magnetic attraction force between the first magnetic area 52 and the second magnetic area 23. Moreover, the casing 22 can reduce the magnetic force from upper and lower surfaces of the second magnetic area 23.

It should be noted that the first magnetic area 52 may also be an independent magnetic object or magnetic induction material disposed on the base 51. When the first magnetic area 52 is a magnetic object, the second magnetic area 23 may also be a magnetic induction material disposed on the key cap 21. Furthermore, in another embodiment, the first magnetic area 52 and the second magnetic area 23 both may be magnetic objects. In other words, one of the first magnetic area 52 and the second magnetic area 23 is a magnetic object and the other one of the first magnetic area 52 and the second magnetic area 23 is a magnetic object or a magnetic induction material according to practical applications. Moreover, the second magnetic area 23 may also be disposed on the key cap 21 directly without the casing 22.

The first linking bar 31 and the second linking bar 32 are disposed between the base 51 and the key cap 21 and are movably connected to the base 51 and the key cap 21. In this embodiment, the first linking bar 31 and the second linking bar 32 are parallel to each other and capable of rotating in an identical direction, so as to drive the key cap 21 to move with respect to the base 51 between a non-pressed position (as shown in FIG. 3) and a pressed position (as shown in FIG. 5). In this embodiment, two end portions of each of the first linking bar 31 and the second linking bar 32 are, but not limited to, rotatably connected to the pivot sockets 53 of the base 51, and a central portion of each of the first linking bar 31 and the second linking bar 32 is, but not limited to, rotatably connected to a pivot socket 24 of the key cap 21. Accordingly, the key cap 21 can move with the first linking bar 21 and the second linking bar 32 between the non-pressed position (as shown in FIG. 3) and the pressed position (as shown in FIG. 5). Still further, the base 51 further has four block plates 54 located outside the four pivot sockets 53 and used for restraining the first linking bar 31 and the second linking bar 32 from moving laterally.

When the key cap 21 is not pressed, a magnetic attraction force between the first magnetic area 52 and the second magnetic area 23 keeps the key cap 21 at the non-pressed position (as shown in FIG. 3). At this time, the first linking bar 31 and the second linking bar 32 are parallel to each other and an angle α1 is included between the base 51 and each of the first linking bar 31 and the second linking bar 32. When the key cap 21 is pressed by an external force, which can overcome the magnetic attraction force, such that the second magnetic area 23 moves away from the first magnetic area 52, the first linking bar 31 and the second linking bar 32 rotate toward the base 51 simultaneously such that the key cap 21 moves with the first linking bar 31 and the second linking bar 32 from the non-pressed position to the pressed position (as shown in FIG. 5). At this time, the key cap 21 rotates toward the base 51 with the first linking bar 31 and the second linking bar 32, such that a moving trajectory of the key cap 21 is arc-shaped while the key cap 21 moves with respect to the base 51 between the non-pressed position and the pressed position. After the key cap 21 is pressed, the first linking bar 31 and the second linking bar 32 are still parallel to each other and an angle α2 is included between the base 51 and each of the first linking bar 31 and the second linking bar 32, wherein the angle α2 after press is smaller than the angle α1 before press. When the external force is removed, the second magnetic area 23 moves toward the first magnetic area 51 due to the magnetic attraction force, such that the key cap 21 drives the first linking bar 31 and the second linking bar 32 to rotate away from the base 51 simultaneously and then the key cap 21 moves with the first linking bar 31 and the second linking bar 32 from the pressed position toward the non-pressed position. As shown in FIG. 5, when the key cap 21 is pressed to the pressed position, a trigger portion 25 formed on the bottom of the key cap 21 will trigger a switch of the circuit board 41 so as to execute input function correspondingly.

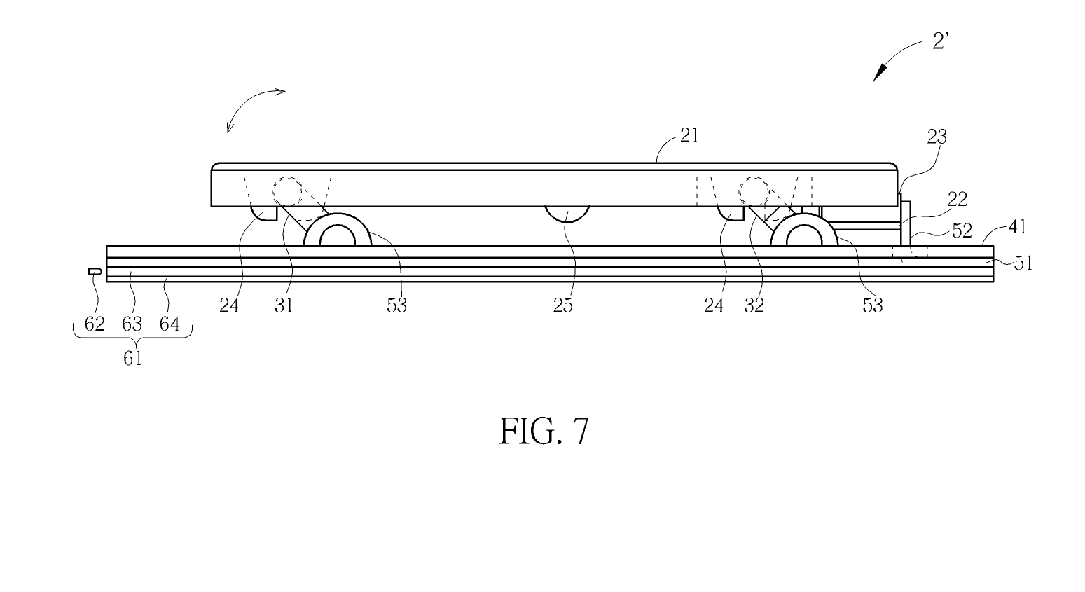

Referring to FIG. 7, FIG. 7 is a side view illustrating a keyswitch 2′ according to another embodiment of the invention. The main difference between the keyswitch 2′ and the aforesaid keyswitch 2 is that the keyswitch 2′ further comprises a backlight device 61, wherein the backlight device 61 is disposed below the base 51 and provides light for the key cap 21. As shown in FIG. 7, the backlight device 61 may essentially consist of a light emitting unit (e.g. light emitting diode) 62, a light guide plate 63, a reflective sheet 64, and so on. The backlight device 61 is well-known by one skilled in the art, so it will not be depicted herein in detail. In this embodiment, the base 51 of the keyswitch 2′ may be transparent, such that the light emitted by the backlight device 61 can pass through the base 51 and be projected toward the key cap 21. Consequently, the keyswitch 2′ generates lighting effect. It should be noted that if the base 51 is opaque, the base 51 may have a hole (not shown) formed thereon, such that light emitted by the backlight device 61 can pass through the hole of the base 51 and be projected toward the key cap 21. Consequently, the keyswitch 2′ can also generate lighting effect. Furthermore, the same elements in FIG. 7 and FIGS. 1-6 are represented by the same numerals, so the repeated explanation will not be depicted herein again.

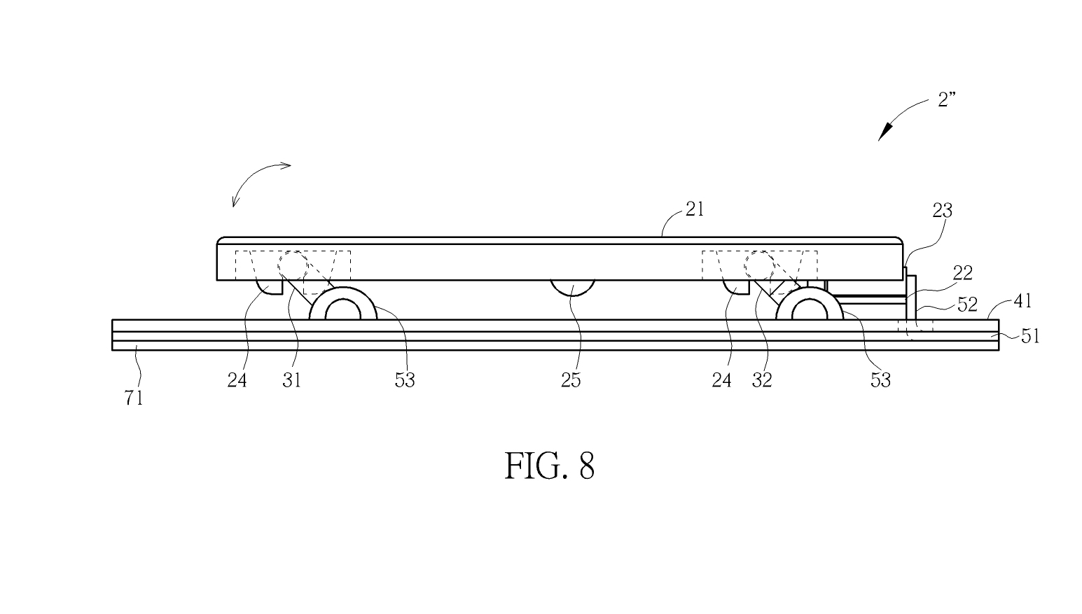

Referring to FIG. 8, FIG. 8 is a side view illustrating a keyswitch 2″ according to another embodiment of the invention. The main difference between the keyswitch 2″ and the aforesaid keyswitch 2 is that the base 51 of the keyswitch 2″ is plastic and the keyswitch 2″ further comprises a capacitance sensing device 71, wherein the capacitance sensing device 71 is disposed below the base 51 and used for providing a cursor signal or a key-on signal. It should be noted that FIG. 8 and FIGS. 1-6 are represented by the same numerals, so the repeated explanation will not be depicted herein again.

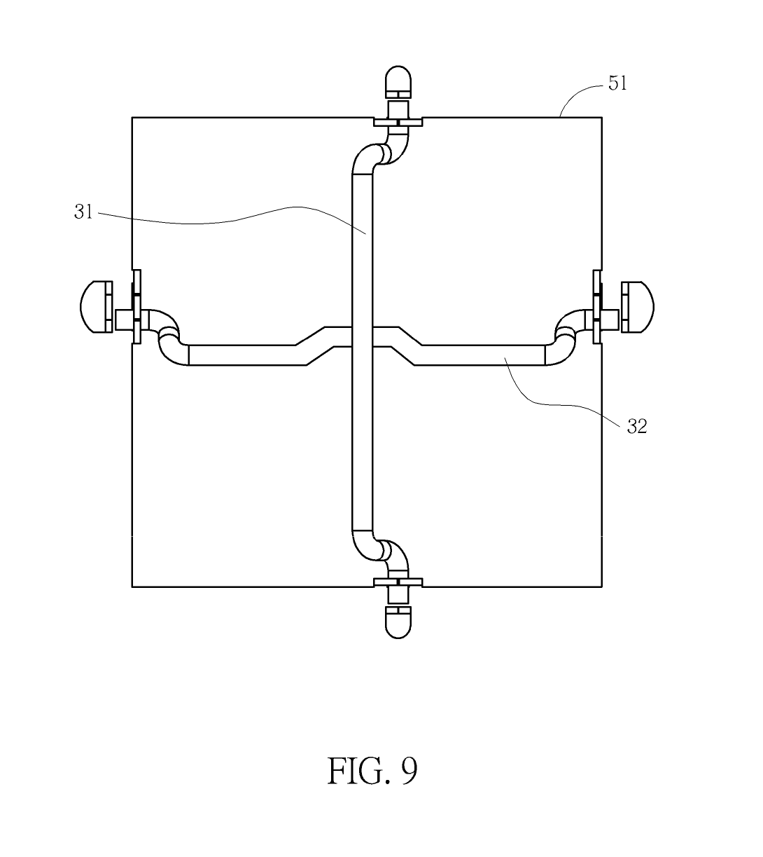

Referring to FIG. 9, FIG. 9 is a top view illustrating an assembly of the first linking bar 31, the second linking bar 32 and the base 51. As shown in FIG. 9, in this embodiment, the first linking bar 31 and the second linking bar 32 are perpendicular to each other, wherein the first linking bar 31 is rotatably connected to the base 51 and the second linking bar 32 is slidably connected to the base 51. When the first linking bar 31 and the second linking bar 32 shown in FIGS. 1 to 6 are replaced with the first linking bar 31 and the second linking bar 32 shown in FIG. 9, the first linking bar 31 and the second linking bar 32 can also drive the key cap 21 to move with respect to the base 51 between the non-pressed position shown in FIG. 3 and the pressed position shown in FIG. 5.

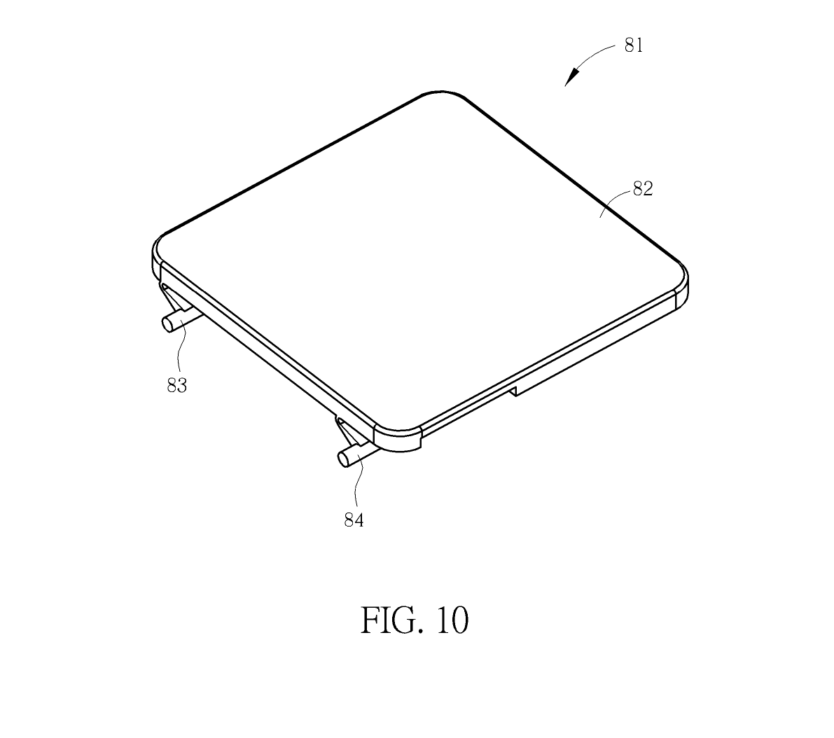

Referring to FIG. 10, FIG. 10 is a perspective view illustrating a key cap 81 according to another embodiment of the invention. As shown in FIG. 10, in this embodiment, the key cap 81 has a main body 82, a first extending arm 83 and a second extending arm 84, wherein the first extending arm 83 and the second extending arm 84 are rotatably connected the aforesaid base 51 and capable of rotating in an identical direction, so as to drive the key cap 81 to move with respect to the base 51 between the non-pressed position shown in FIG. 3 and the pressed position shown in FIG. 5. Furthermore, parts of the first extending arm 83 and the second extending arm 84 close to the key cap 81 are thin and capable of deforming. In this embodiment, the main body 82, the first extending arm 83 and the second extending arm 84 may be formed integrally or independently. In other words, the invention may replace the key cap 21, the first linking bar 31 and the second linking bar 32 shown in FIGS. 1 to 6 with the key cap 81 shown in FIG. 10.

As mentioned in the above, the invention disposes the first magnetic area on the base and disposes the second magnetic area on the key cap, wherein the position of the first magnetic area is corresponding to the position of the second magnetic area. Furthermore, the invention may dispose two linking bars, which are movably connected to the base and the key cap, between the base and the key cap or, alternatively, the invention may dispose two extending arms, which are rotatably connected to the base, on the key cap. When the key cap is not pressed, the magnetic attraction force between the first magnetic area and the second magnetic area keeps the key cap at the non-pressed position. When the key cap is pressed by the external force such that the second magnetic area moves away from the first magnetic area, the key cap moves with the two linking bars or the two extending arms from the non-pressed position toward the pressed position. When the external force is removed, the second magnetic area moves toward the first magnetic area due to the magnetic attraction force such that the key cap moves with the two linking bars or the two extending arms from the pressed position toward the non-pressed position. Since the upright elastomeric biasing member of the conventional keyswitch is unnecessary for the invention, the lifetime of the keyswitch of the invention can be extended effectively. Moreover, the invention replaces the support device of the conventional keyswitch with the two linking bars or the two extending arms, such that the structure of the keyswitch is simple, it is easy to assemble the keyswitch, and the keyswitch can be miniaturized easily.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyswitch comprising:
a base;
a first magnetic area disposed on the base;
a key cap;
a second magnetic area disposed on the key cap, a position of the second magnetic area being corresponding to a position of the first magnetic area; and
a first linking bar and a second linking bar disposed between the base and the key cap, the first and second linking bars being movably connected to the base and the key cap, so as to drive the key cap to move with respect to the base between a non-pressed position and a pressed position;
wherein when the keycap is not pressed, a magnetic attraction force between the first magnetic area and the second magnetic area keeps the key cap at the non-pressed position; when the key cap is pressed by an external force such that the second magnetic area moves away from the first magnetic area, the key cap moves with the first and second linking bars from the non-pressed position toward the pressed position; when the external force is removed, the second magnetic area moves toward the first magnetic area due to the magnetic attraction force such that the key cap moves with the first and second linking bars from the pressed position toward the non-pressed position.

2. The keyswitch of claim 1, wherein the first and second linking bars are parallel to each other and capable of rotating in an identical direction, so as to drive the key cap to move with respect to the base between the non-pressed position and the pressed position.

3. The keyswitch of claim 1, wherein the first and second linking bars are perpendicular to each other, so as to drive the key cap to move with respect to the base between the non-pressed position and the pressed position.

4. The keyswitch of claim 3, wherein the first linking bar is rotatably connected to the base and the second linking bar is slidably connected to the base.

5. The keyswitch of claim 1, wherein one of the first magnetic area and the second magnetic area is a magnetic object and the other one of the first magnetic area and the second magnetic area is a magnetic object or a magnetic induction material.

6. The keyswitch of claim 1, wherein a side plate is bent from the base so as to form the first magnetic area.

7. The keyswitch of claim 1, wherein the second magnetic area is disposed on four corners or a center of a bottom of the key cap.

8. The keyswitch of claim 1, further comprising a casing disposed on a bottom of the key cap and used for accommodating the second magnetic area.

9. The keyswitch of claim 1, wherein a moving trajectory of the key cap is arc-shaped while the key cap moves with respect to the base between the non-pressed position and the pressed position.

10. The keyswitch of claim 1, wherein the base has a hole formed thereon, the keyswitch further comprises a backlight device disposed below the base, and the backlight device provides light for the key cap.

11. The keyswitch of claim 1, wherein the base is transparent, the keyswitch further comprises a backlight device disposed below the base, and the backlight device provides light for the key cap.

12. The keyswitch of claim 1, wherein the base is plastic, the keyswitch further comprises a capacitance sensing device disposed below the base, and the capacitance sensing device is used for providing a cursor signal or a key-on signal.

13. A keyswitch comprising:
a base;
a first magnetic area disposed on the base;
a key cap having a main body, a first extending arm and a second extending arm, the first and second extending arms being rotatably connected to the base and capable of rotating in an identical direction, so as to drive the key cap to move with respect to the base between a non-pressed position and a pressed position; and
a second magnetic area disposed on the key cap, a position of the second magnetic area being corresponding to a position of the first magnetic area; and
wherein when the keycap is not pressed, a magnetic attraction force between the first magnetic area and the second magnetic area keeps the key cap at the non-pressed position; when the key cap is pressed by an external force such that the second magnetic area moves away from the first magnetic area, the key cap moves with the first and second extending arms from the non-pressed position toward the pressed position; when the external force is removed, the second magnetic area moves toward the first magnetic area due to the magnetic attraction force such that the key cap moves with the first and second extending arms from the pressed position toward the non-pressed position.

14. The keyswitch of claim 13, wherein one of the first magnetic area and the second magnetic area is a magnetic object and the other one of the first magnetic area and the second magnetic area is a magnetic object or a magnetic induction material.

15. The keyswitch of claim 13, wherein a side plate is bent from the base so as to form the first magnetic area.

16. The keyswitch of claim 13, wherein the second magnetic area is disposed on four corners or a center of a bottom of the key cap.

17. The keyswitch of claim 13, further comprising a casing disposed on a bottom of the key cap and used for accommodating the second magnetic area.

18. The keyswitch of claim 13, wherein a moving trajectory of the key cap is arc-shaped while the key cap moves with respect to the base between the non-pressed position and the pressed position.

19. The keyswitch of claim 13, wherein the base has a hole formed thereon, the keyswitch further comprises a backlight device disposed below the base, and the backlight device provides light for the key cap.

20. The keyswitch of claim 13, wherein the base is transparent, the keyswitch further comprises a backlight device disposed below the base, and the backlight device provides light for the key cap.

21. The keyswitch of claim 13, wherein the base is plastic, the keyswitch further comprises a capacitance sensing device disposed below the base, and the capacitance sensing device is used for providing a cursor signal or a key-on signal.

22. The keyswitch of claim 13, wherein the main body, the first extending arm and the second extending arm are formed integrally.
